(19) United States
(12) Patent Application Publication
(10) Pub. No.: US 2026/0285615 A1
(43) Pub. Date: Sep. 24, 2026

(54) METHOD FOR AUTOMATICALLY REGULATING A CONTAINER TRANSPORT APPARATUS HAVING ONE OR MORE TRANSPORT BELTS FOR ADAPTING A CONTAINER DENSITY, AND CONTAINER TRANSPORT APPARATUS

(71) Applicant: KRONES AG, Neutraubling (DE)

(72) Inventors: Thomas ALBRECHT, Beilngries (DE); Benedikt BOETTCHER, Bruckmühl (DE)

(21) Appl. No.: 18/881,225

(22) PCT Filed: Apr. 13, 2023
(86) PCT No.: PCT/EP2023/059615

§ 371 Date: Jan. 3, 2025

(30) Foreign Application Priority Data
Jul. 7, 2022 (DE) 10 2022 116 944.8

(51) Int. Cl. B65G 47/31; B65G 43/08; B65G 43/10

(52) U.S. Cl. CPC B65G 47/31; B65G 43/08; B65G 43/10; B65G 2201/0235; B65G 2203/0233; B65G 2203/044

(57) ABSTRACT

The invention relates to a method for automatically regulating a container transport apparatus having one or more transport belts for adapting a container density of containers which are transported on the one or more transport belts. The method comprises, in each case at different times, detection of distance data relating to containers on the one or more transport belts by a distance measurement apparatus, transmission of the distance data to a control apparatus by the distance measurement apparatus, processing of the distance data to give control data in the control apparatus, and non-linear regulation of belt speeds of the one or more transport belts by the control data. The invention further relates to a container transport apparatus comprising one or more transport belts and to a control apparatus, wherein the container transport apparatus is configured to carry out a method.

### CROSS REFERENCE TO RELATED APPLICATION

The present application is a U.S. National Phase of International Application No. PCT/EP2023/059615 entitled “METHOD FOR AUTOMATICALLY REGULATING A CONTAINER TRANSPORT DEVICE HAVING ONE OR MORE TRANSPORT BELTS FOR ADAPTING A CONTAINER DENSITY, AND CONTAINER TRANSPORT DEVICE,” and filed on Apr. 13, 2023. International Application No. PCT/EP2023/059615 claims priority to German Patent Application No. 10 2022 116 944.8 filed on Jul. 7, 2022. The entire contents of each of the above-listed applications are hereby incorporated by reference for all purposes.

### TECHNICAL FIELD

The invention relates to methods for automatically regulating a container transport apparatus having one or more transport belts for adapting a container density of containers according to claim 1 and a container transport apparatus according to claim 15.

BACKGROUND AND SUMMARY DE 195 30 626 A1 discloses a method and an apparatus for detection of the occupancy of a conveyor for vessels with an accumulation and/or deflection region, wherein the occupancy is detected in a contactless manner by a distance measurement, which is carried out substantially parallel to the conveying plane, between a reference location upstream of the accumulation and a rearmost vessel of the accumulated container flow.

In general, there is currently no or insufficient regulation of container density during container transport on a transport belt. As a result, high pressures on containers can arise, which can lead to glass breakage or scuffing (abrasion, scratches) and which are undesirable when transporting sensitive plastic containers (e.g., made of PET) or other thin-walled or sensitive containers, such as cans made of aluminum or tinplate. Containers colliding with one another can also cause noise and can lead to deviations from the desired target distribution of containers on the transport belt.

### OBJECT

The object of the invention is to provide a method and a container transport apparatus that make possible gentle and quiet transport of containers on transport belts.

### SOLUTION

The objective is achieved by the method according to claim 1 and the container transport apparatus according to claim 15. Preferred embodiments are disclosed in the dependent claims.

A method for automatically regulating a container transport apparatus having one or more transport belts for adapting a container density of containers which are transported on the one or more transport belts comprises, in each case at different times, detection of distance data relating to containers on the one or more transport belts by a distance measurement apparatus, transmission of the distance data to a control apparatus by the distance measurement apparatus, processing of the distance data to give control data in the control apparatus, and non-linear regulation of belt speeds of the one or more transport belts by the control data.

The distance measurement apparatus can comprise various types of sensors, which are configured to detect the position of objects, for example containers. This can be carried out optically (light barrier) and/or mechanically (accumulation switch), by sound sensor, by a camera, by Hall sensors and/or by proximity sensors.

The distance data can comprise a distance from one container to another container, or the distances between one container and a plurality of other containers, and/or the distances between a plurality of containers and one container, and/or the distances between a plurality of containers and a plurality of other containers, and/or a distance between one container and a railing, and/or the distances between a plurality of containers and a railing. Alternatively, the distance data can comprise a number of containers present in a defined region and/or a distribution of the containers in a defined region.

The one or more transport belts can be assigned an identity in each case.

Linear or non-linear regulation can be used for regulation in which an output signal is not always proportional to the input signal.

Here, the non-linear regulation is used to regulate the speeds of one or more transport belts. If a plurality of transport belts are present, the speed and direction of motion of the other transport belts can be taken into account for each of the transport belts when regulating its own speed. In addition, the speeds can be controlled in such a way that a changing number of containers fed in can be responded to, so that a container density on the plurality of transport belts can be adapted at any time.

The detection of distance data by the distance measurement apparatus can comprise infrared, sound, sonar and/or laser, lidar, and/or a mechanical distance measurement, such as one or more accumulation switches. It is also possible to ascertain the distances by an image or a video stream; in so doing, the distance between two or more containers detected in the image in relation to the known container diameter is set.

The detection of distance data can be carried out continuously or in cycles. For example, a distance between a container and at least one adjacent container can be detected or the distances between a plurality of containers can be detected. The distance data can comprise the information specified in the list above.

The non-linear regulation can comprise setting a speed gradient across the plurality of transport belts. For example, the speed gradient can increase if there is an accumulation in the container transport apparatus. For example, the speed gradient can decrease at distances which exceed a given distance value.

A first speed gradient can be set for transport belts moving in a first direction, and a second speed gradient can be set for transport belts moving in a second direction. The first and second speed gradients can be the same or different.

A gradient can indicate the course of a change (decline or rise) of a quantity over a certain distance. Here, the quantity can be viewed as the speed of the transport belts or the rotational speed of the drive motors and the distance can be viewed here as a first, second, third, etc. transport belt. The first transport belt can be arranged adjacent to the second, the second adjacent to the third transport belt, etc., or the first, second, third, etc. transport belts can be connected in series.

The non-linear regulation can further comprise adjustment of electrically adjustable railings and/or deflector plates and/or lane guides of the one or more transport belts and/or adjustment of an inclination of the one or more transport belts relative to a horizontal plane. For example, in the case of electrically adjustable railings and/or deflector plates and/or lane guides divided into sections, the adjustment can comprise a section-by-section adjustment.

Due to the adjustment, for example, the space available for containers between the electrically adjustable railings and/or deflector plates and/or lane guides of the one or more transport belts can be increased or reduced. An additional buffer can be created during the ongoing operation of the container transport apparatus due to an adjustment that increases the available space.

The non-linear regulation can further comprise control of a plurality of points of one or more elastically configured deflector plates of the one or more transport belts for adapting a contour of the one or more elastically configured deflector plates.

The transport and/or redirection of the containers can be configured to be gentle by this control.

The method can further comprise detection of current occupancy data of an occupancy of the one or more transport belts with containers by one or more position measurement apparatuses. For example, detection can comprise recording images with one or more cameras.

The positioning apparatuses can, for example, detect the position data of one or more containers. Conclusions can be drawn about the occupancy of one or more transport belts with containers based on the quantity of position data.

The position measurement apparatuses can also or alternatively detect position data, which can also comprise, for example, distance data as specified in the list above.

The method can further comprise transmission of the current occupancy data to a central computer unit, processing of the current occupancy data with an algorithm available on the central computer unit to produce processed occupancy data and use of the processed occupancy data for regulating drives of the one or more transport belts. Instead of or in addition to the central computer unit, transmission of the current occupancy data can comprise transmission of the current occupancy data to a cloud, a smart device, PLC (programmable logic controller) and/or IPC (inter-process communication). Alternatively or additionally, the current occupancy data can be detected using a smart device, which for example comprises a smart camera, and can also be processed into processed occupancy data using an algorithm available on the smart device, and these processed occupancy data can be used to regulate drives of the one or more transport belts.

For example, processing can be carried out continuously.

For example, the processed occupancy data can be compared with a specified occupancy (target occupancy) of the one or more transport belts with containers. If the specified occupancy is exceeded, the regulation can, for example, require an increase in the drive speed. If the specified occupancy is not met, the regulation can, for example, require a reduction or an increase in the drive speed.

The method can further comprise processing of the current occupancy data with a further algorithm available on the central computer unit and therefrom calculation of a speed for the one or more transport belts with the further algorithm.

Instead of or in addition to processing with the further algorithm available on the central computing unit, processing the current occupancy data can be carried out with a further algorithm available on a/the cloud, a/the smart device, a/the PLC (programmable logic controller), and/or a/the IPC (inter-process communication).

For example, the method can further comprise calculation of an adjustment of electrically adjustable railings and/or deflector plates and/or lane guides of the one or more transport belts and/or adjustment of an inclination of the one or more transport belts relative to a horizontal plane. For example, in the case of electrically adjustable railings and/or deflector plates and/or lane guides divided into sections, the adjustment can comprise a section-by-section adjustment.

The method can additionally or alternatively comprise prediction and/or learning of a strategy for adjusting electrically adjustable railings and/or deflector plates and/or lane guides of the one or more transport belts and/or adjustment of an inclination of the one or more transport belts relative to a horizontal plane. For example, prediction and/or learning can comprise reaching a specified occupancy level of the transport belt or reaching specified occupancy levels of the transport belts.

If a specified occupancy is exceeded, it can be provided that the space between the electrically adjustable railings and/or deflector plates and/or lane guides of the one or more transport belts can be increased by adjusting them. If the specified occupancy is not met, it can be provided that the space between the electrically adjustable railings and/or deflector plates and/or lane guides of the one or more transport belts can be reduced by adjusting them.

The further algorithm can comprise a neural network or model-based online optimization. With model-based online optimization, the model can learn the behavior of the container transport apparatus in a training program. By online optimization, a regulation of the container transport apparatus can be carried out during operation of the container transport apparatus in the event of a deviation from the desired behavior (model predictive control).

For example, the neural network can comprise an observation layer, which can be followed by a fully connected layer. Subsequently, a ReLU activation function can be provided four times, followed by a fully connected layer. The fifth fully connected layer can be followed by a Tanh activation function. The Tanh activation function can be followed by a scaling layer. The output of the neural network can be input into a function for ascertaining a mean square error.

An output node of the neural network can comprise a Tanh activation function. Due to the Tanh activation function, proposed actions to the region [−1, 1] can be mapped.

This can be useful if a scaling layer follows the Tanh activation function. For example, it may be easier to map the output of the neural network to a defined range [min, max] of each belt speed of the one or more transport belts.

For example, the speed of a second transport belt can have a defined range of [0.8 0.6]m/s and the speed of a third belt can have a defined range of [0.7, 0.5], so that the output of the Tanh activation function maps the value to the range [−1, 1] and in a subsequent scaling layer each belt speed action can be adapted to the respective defined range.

The neural network can comprise at least one hidden layer and each of the at least one hidden layer can comprise a ReLU activation function. Of the known activation functions, the ReLU activation function, with its piecewise linear function, is a suitable choice. For example, it can output an input directly if the input is positive and output zero if the input is not positive.

An output of the neural network can comprise an array. For example, the array can comprise a respective assignment of the identity of the transport belt to its belt speed or an identity of one of the plurality of transport belts to its belt speed.

The neural network can comprise at least one fully connected layer, as a result of which the neural network can learn features from all combinations of features of the previous layer.

Calculations of neurons in the neural network can depend on the outputs of the preceding layers, which may have been multiplied by weights and occupied with an offset.

For training the neural network, training data can be generated by an agent in the form of trials and errors. At the beginning of training, the agent can try random actions and can evaluate the result (reward function). Subsequently, the agent can adjust these actions until the optimal actions are identified. The action can also be added to a noise function in order to allow the agent to explore uncontested states. The agent can store these states in a buffer of a fixed size. For each iteration, the weights of the neural network can be updated with a randomly selected mini-batch from the buffer, so that the data can be distributed independently (this happens because the agent itself generated the training data).

This data, which can be the input of the neural network, can be uniform regions that can cover a portion of a transport belt in order to calculate the occupancy, for example an occupancy rate, of each of these regions and to determine whether the containers are evenly distributed. If the containers are not evenly distributed, the agent can adapt the action every n seconds in order to ensure that the containers are evenly distributed.

For example, the number of uniform regions can be 5, 11 or 22 or less or more. The data can also be an image or video from the camera showing the occupancy of the regions with containers.

A container transport apparatus comprises one or more transport belts and a control apparatus, wherein the container transport apparatus is configured to carry out a method as described above or below.

### BRIEF DESCRIPTION OF THE FIGURES

The accompanying figures show, by way of example, aspects and/or exemplary embodiments of the invention for better understanding and illustration. In the drawings:

FIG. 1 schematically shows the layers of a neural network,

FIG. 2 schematically shows an oblique view of a plurality of transport belts and a subsequent mass transport with a first number of uniform regions and

FIG. 3 schematically shows an oblique view of the plurality of transport belts and the subsequent mass transport with a second number of uniform regions.

### DETAILED DESCRIPTION OF THE FIGURES

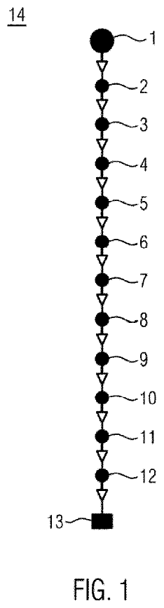

FIG. 1 shows a schematic representation of the layers of a neural network 14 as it can be used for the method and the container transport apparatus as described above or below. Another or similar neural network can also be used.

The observation layer 1 is followed by a first fully connected layer 2, so that the neural network 14 can learn the features from all combinations of features of the observation layer 1.

The first fully connected layer 2 is followed by a first ReLU activation function 3. For example, it can output an input directly if the input is positive and output zero if the input is not positive. The results of the first ReLU activation function 3 are passed to a second fully connected layer 4, so that the neural network 14 can learn the features from all combinations of features of the previous layers.

The second fully connected layer 4 is followed by a second ReLU activation function 5. For example, the second ReLU activation function 5 can also output an input directly if the input is positive and output zero if the input is not positive. The results of the second ReLU activation function 5 are passed to a third fully connected layer 6, so that the neural network 14 can learn the features from all combinations of features of the previous layers.

The third fully connected layer 6 is followed by a third ReLU activation function 7. For example, the third ReLU activation function 7 can also output an input directly if the input is positive and output zero if the input is not positive. The results of the third ReLU activation function 7 are passed to a fourth fully connected layer 8, so that the neural network 14 can learn the features from all combinations of features of the previous layers.

The fourth fully connected layer 8 is followed by a fourth ReLU activation function 9. For example, the fourth ReLU activation function 9 can also output an input directly if the input is positive and output zero if the input is not positive. The results of the fourth ReLU activation function 9 are passed to a fifth fully connected layer 10, so that the neural network 14 can learn the features from all combinations of features of the previous layers.

The fifth fully connected layer 10 is followed by a Tanh activation function 11. Proposed actions can be mapped to the range [−1, 1] by the Tanh activation function 11.

The Tanh activation function 11 is followed by a scaling layer 12. The previous Tanh activation function 11 can make it easier to map the output of the neural network to a defined range [min, max].

The output of the neural network 14 is input into a function 13 for ascertaining a mean square error.

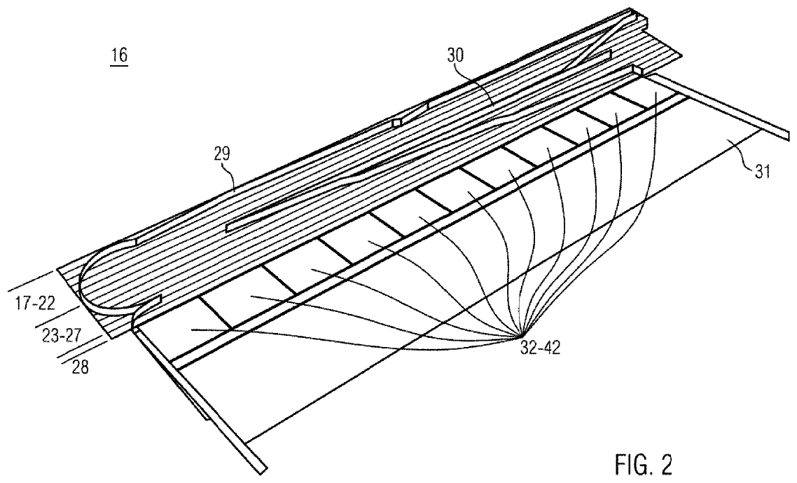

FIG. 2 shows schematically an oblique view of a system 16, which comprises a plurality of transport belts 17-22, 23-27, 28 and a subsequent mass transport 31 with a first number of uniform regions 32-42. Here, the first number is 11. A first group of transport belts 17-22 and a single transport belt 28 can be driven in a first direction and a second group of transport belts 23-27 in a second direction, wherein the first and second directions are oriented opposite to each other. In the representation, the mass transport 31 can be driven in a third direction that is perpendicular to the first and second directions. The mass transport 31 can also be driven in a fourth direction that is opposite to the third direction.

Above the transport belts 17-22, 23-27, 28, railings 29, 30 are provided, which can be used for guiding and/or diverting containers transported on the transport belts 17-22, 23-27, 28. The railings 29, 30 can be electrically adjustable railings. Instead of railings or in addition to them, deflector plates and/or lane guides can be provided.

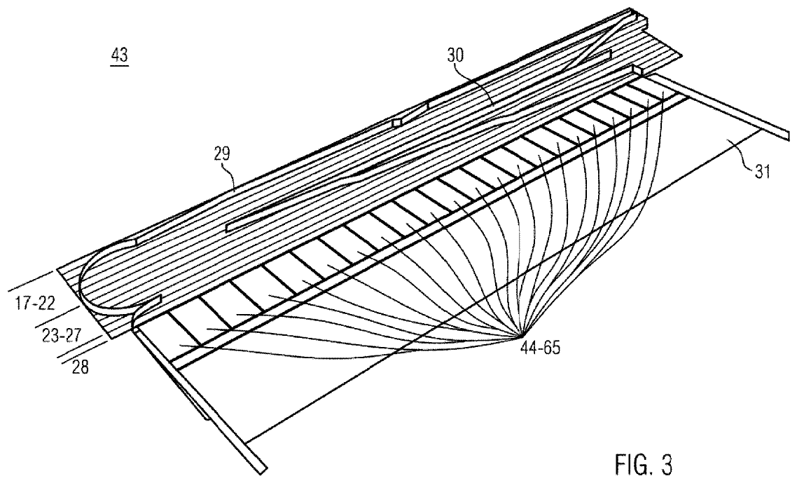

FIG. 3 shows a schematic oblique view of a system 43, the transport belts 17-22, 23-27, 28 and the subsequent mass transport 31 of which are provided as with the transport belts 17-22, 23-27, 28 and mass transport 31 already described with regard to FIG. 2. The second number of uniform regions 44-65 is 22 in the representation.

As a result of the fact that the second number is larger than the first number, a better adjustment of the container density, i.e. the occupancy, can be achieved for the second system, in which the second number of uniform regions 44-65 is used.

1. A method for automatically regulating a container transport apparatus having one or more transport belts for adapting a container density of containers which are transported on the one or more transport belts wherein the method comprises:
in each case at different times:
Detection of distance data relating to containers on the one or more transport belts 28) by a distance measurement apparatus,
Transmission of the distance data to a control apparatus by the distance measurement apparatus,
Processing of the distance data to give control data in the control apparatus,
Non-linear regulation of belt speeds of the one or more transport belts by the control data.

2. The method according to claim 1, wherein the detection of the distance data by the distance measurement apparatus comprises infrared, sound, sonar and/or laser and/or a mechanical distance measurement, such as one or more accumulation switches.

3. The method according to claim 1, wherein the detection of distance data is carried out continuously or in cycles.

4. The method according to claim 1, wherein the non-linear regulation comprises:
Setting a speed gradient across the plurality of transport belts.

5. The method according to claim 1, wherein the non-linear regulation further comprises an adjustment of electrically adjustable railings and/or deflector plates and/or lane guides of the one or more transport belts and/or an adjustment of an inclination of the one or more transport belts relative to a horizontal plane.

6. The method according to claim 1, wherein the non-linear regulation further comprises control of a plurality of points of one or more elastically configured deflector plates of the one or more transport belts for adapting a contour of the one or more elastically configured deflector plates.

7. The method according to claim 1, further comprising:
Detection of current occupancy data of an occupancy of the one or more transport belts with containers by one or more position measurement apparatuses.

8. The method according to claim 7, further comprising:
Transmission of the current occupancy data to a central computer unit,
Processing of the current occupancy data with an algorithm available on the central computer unit to produce processed occupancy data,
Use of processed occupancy data for regulating drives of one or more transport belts.

9. The method according to claim 8, further comprising:
Processing of the current occupancy data with a further algorithm available on the central computer unit and therefrom calculation of a speed for the one or more transport belts with the further algorithm.

10. The method according to claim 9, wherein the further algorithm comprises a neural network or a model-based online optimization.

11. The method according to claim 10, wherein an output node of the neural network comprises a Tanh activation function.

12. The method according to claim 10, wherein the neural network comprises at least one hidden layer and each of the at least one hidden layer comprises a ReLU activation function, wherein the ReLU activation function is a piecewise linear function that outputs an input directly when the input is positive and outputs zero when the input is not positive.

13. The method according to claim 10, wherein an output of the neural network comprises an array, wherein the array comprises a respective assignment of an identity of the transport belt to its belt speed or an identity of one of the plurality of transport belts to its belt speed.

14. The method according to claim 10, wherein the neural network comprises at least one fully connected layer, as a result of which the neural network learns features from all combinations of features of the previous layer.

15. A container transport apparatus comprising one or more transport belts and a control apparatus, wherein the container transport apparatus is configured to carry out a method according to claim 1.

16. The method according to claim 3 wherein a distance of a container to at least one adjacent container is detected or the distances of a plurality of containers to one another are detected.

17. The method according to claim 4, wherein the speed gradient increases in the event of an accumulation in the container transport apparatus, wherein the speed gradient decreases at distances exceeding a given distance value.

18. The method according to claim 5, wherein in the case of electrically adjustable railings and/or deflector plates and/or lane guides divided into sections, the adjustment comprises a section-by-section adjustment.

19. The method according to claim 7, wherein detection comprises recording images with one or more cameras.

20. The method according to claim 9, wherein processing is carried out continuously, and further with calculation of an adjustment of electrically adjustable railings and/or deflector plates and/or lane guides of the one or more transport belts, wherein, in the case of electrically adjustable railings and/or deflector plates and/or lane guides divided into sections, the adjustment comprises section-by-section adjustment.
